(19) United States
(12) Patent Application Publication
(10) Pub. No.: US 2005/0027026 A1
(43) Pub. Date: Feb. 3, 2005

(54) Flexible polyurethane foam

(75) Inventor: Hideya Kinoshita, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/900,348

(22) Filed: Jul. 28, 2004

(30) Foreign Application Priority Data
Jul. 31, 2003 (JP) 2003-284021

(51) Int. Cl. C08G 18/00

(52) U.S. Cl. 521/155

(57) ABSTRACT

A flexible polyurethane foam which is weak acid when it is wet is manufactured by mixing a compound of a polyol component containing a weak acid component and polyisocyanate component and foaming them. The weak acid polyurethane foam contains acrylic sodium and/or polymers thereof as the weak acid component. The polyurethane foam is weak acid when it is wet because of the weak acidity of the acrylic sodium.

### FIELD OF THE INVENTION

The present invention relates to a flexible polyurethane foam the surface of which is weak acid when it is wet.

### BACKGROUND OF THE INVENTION

Flexible polyurethane foams have been widely used, e.g. as bath sponges, etc. Developments for further improving the properties thereof including the water absorption properties, dewatering properties, flexibility, elastic properties, etc. have been conducted. The conventional flexible polyurethane foams are approximately neutral (pH 7) when they are wet.

As for skin washes such as body soap, face soap, etc., products having weak acidity have been placed on the market in anticipation that they does not irritate human's skin. Healthy human's skin is weak acid, such as pH 5.5 or so, and the weak acidity protects the human's skin from foreign irritations and dryness. The weak acid skin washes maintain the weak acidity of human's skin so as to make the human's skin after washing resistive against foreign irritations and dryness.

### SUMMARY OF THE INVENTION

It is an object of the present invention to provide a flexible polyurethane foam which is weak acid when it is wet.

A flexible polyurethane foam of the present invention contains a weak acid component, and thus is weak acid when it is wet.

### DETAILED DESCRIPTION OF THE PREFERRED EMBODIMENTS

The flexible polyurethane foam of the present invention is useful for skin washing materials such as bath sponges, etc., and for various applications in which the weak acidity is required in a wet state, because the polyurethane foam of the present invention is weak acid when it is wet.

The polyurethane foam of the present invention may be manufactured by foaming a raw compound containing a weak acid component. The raw compound may contain a polyol component, and at least a part of the polyol component may be a polyol containing the weak acid component. The weak acid component may be an acrylic metallic salt, such as acrylic sodium and/or polymers thereof.

The weak acid polyol containing the weak acid component may be polyether polyol added with propylene oxide, ethylene oxide or the like by using glycerin, trimethylol propane, diethylene glycol, or the like as an initiator. The hydroxyl value of the polyol is preferable to be in a range of 10 to 100, more preferably in a range of 20 to 60, but not limitated thereto.

The content of the weak acid component in the weak acid polyol may be in a range of 5 to 100% by weight.

The weak acid polyol may be prepared by first adding an acrylic alkali metallic salt into a polyol and mixing them, and then polymerizing the acrylic alkali metallic salt in the polyol to produce polymers of the acrylic alkali metallic salt such as polyacrylic sodium. Although the acrylic alkali metallic salt including acrylic sodium does not react with the polyol in usual conditions, polymers of the acrylic alkali metallic salt having an average particle diameter of about 0.5 to 10 μm can be produced by polymerizing the acrylic alkali metallic salt in the polyol. The polymers are in a form of fine particle and are captured within the polyol because the polymers have been produced in the polyol, so that the polymers do not drop out of the polyol and the flexible polyurethane foam easily. Therefore, the flexible polyurethane foam made of the polyol can be used many times without losing its weak acidity.

It should be noted that polymers of the acrylic alkali metallic salt, including polyacrylic sodium resin, produced in accordance with a conventional method usually have an average particle diameter on the order of 100 μm.

The polyurethane foam containing the weak acid component, manufactured by first adding an acrylic alkali metallic salt into a polyol and mixing them, and then polymerizing the acrylic alkali metallic salt in the polyol to produce polymers of the acrylic alkali metallic salt, does not increase viscosity of the compound during the polyurethane foam manufacturing process, whereby the polyurethane foam can be manufactured easily.

The weak acid polyol may be blended with other usual polyols, e.g. including polyether polyol prepared by adding propylene oxide, ethylene oxide or the like to glycerin, trimethylol propane, diethylene glycol or the like as an initiator; polyester polyol produced by adding adipic acid to diethylene glycol, trimethylol propane, glycerin or the like as an initiator; etc., when it is used in the polyurethane foam manufacturing process.

The content of the weak acid component in the total polyol components is preferable to be in a range of 0.75 to 15% by weight. When the content of the weak acid component is below the range, the acidity of a resulting flexible polyurethane foam becomes too weak so that the polyurethane foam will be of almost neutral. When the content of the weak acid component is above the range, the manufacture of a foam will be difficult.

The raw compound for manufacturing the flexible polyurethane foam of the present invention may be the same as that for manufacturing a conventional flexible polyurethane foams except that at least a part of the polyol component is the weak acid polyol containing the weak acid component. Used as polyisocyanate may be one or more than two selected from among 2,4-tolylene diisocyanate (2,4-TDI), 2,6-tolylene diisocyanate (2,6-TDI), diphenyl methane-4,4′-diisocyanate (MDI), polymethylene polyphenyl isocyanate and the like.

Water is suitably used as a foaming agent. Alternately, methylene chloride and the like may be used as the foaming agent.

Used as a catalyst may be an amine catalyst including triethylene diamine, tetramethylene hexadiamine, dimethyl cyclohexylamine, and the like; an organic tin catalyst including stannous octoate, dibutyltin dilaurate and the like; etc.

In the raw compound for manufacturing the flexible polyurethane foam of the present invention, various foam stabilizers, e.g. including siloxane, polyalkylene oxide block copolymer and the like, may be further used. The raw compound may further contain other various additives including a fire retardant, anti-oxidizing agent, ultraviolet absorber, colorant, etc., which are typically contained in usual polyurethane foams.

The flexible polyurethane foam of the present invention may be manufactured by any method such as prepolymer method, one-shot method, partial prepolymer method, etc. The raw compound in these methods may contain water as foaming agent in an amount of 2.0 to 7.0 parts by weight to 100 parts by weight of the polyol component, a catalyst in an amount of 0.2 to 5.0 parts by weight to 100 parts by weight of the polyol component, a foam stabilizer in an amount of 0.5 to 7.0 parts by weight to 100 parts by weight of the polyol component, wherein the isocyanate index is preferable to be in a range of 80 to 120.

The flexible polyurethane foam of the present invention may have a density of 10 to 50 kg/m³ in usual cases.

### EXAMPLE AND COMPARATIVE EXAMPLE

Hereinafter, the present invention will be described in detail with reference to an example and comparative example.

In the example and comparative example, flexible polyurethane foams are manufactured by using raw materials as follows:

Polyol 1: “SQ-527”, available from Sanyo Kasei (polyacrylic sodium-containing polyether polyol produced by first adding acrylic sodium into polyether having been prepared by adding propylene oxide and ethylene oxide to glycerin beforehand, and then polymerizing the acrylic sodium to produce polyacrylic sodium in the polyether, in which the number of functional groups is 3, the average molecular weight is 4800, the hydroxyl value is 29, and the content of the acrylic sodium is 15% by weight.);

Polyol 2: “EX828”, available from Asahi Glass (polyether polyol produced by adding propylene oxide and ethylene oxide to glycerin, in which the number of functional groups is 3, the average molecular weight is 4800, and the hydroxyl value is 33.5.);

Polyisocyanate: “T-80”, available from Mitsui Takeda (tolylene diisocyanate);

Foaming agent: water;

Foam Stabilizer: “PRX607”, available from TORAY (dimethyl polysiloxane);

Catalyst: “NEM”, available from Kao (N-ethyl morpholine);

Foam Stabilizer: “AX-31” available from Sanyo Kasei (dimethyl amine oleate);

Catalyst: “33LV”, available from Air Products (triethyl diamine); and

Foam Stabilizer: “SH192”, available from TORAY (dimethyl polysiloxane).

### Example 1 and Comparative Example 1

The raw compounds of Example 1 and Comparative Example 1 as shown in Table 1 were foamed in accordance with a usual polyurethane foaming method to manufacture flexible polyurethane foams having a density of about 27 kg/m³, respectively. Each of the resulting flexible polyurethane foams was cut into a sample piece having a dimension of 50 mm×70 mm×100 mm.

Each sample piece was submerged in water and crumpled to impregnate it with water (pH7)completely. After that, the sample piece was taken out of the water and then wrung. pH measurements on the surface of these wet sample pieces were made by using pH test papers, respectively. The results of the measurements are shown in Table 1.

TABLE 1

| | | | Comparative |
|---|---|---|---|
| | | Example 1 | Example 1 |
| Raw | Polyol 1 | 30※ | — |
| Compound | Polyol 2 | 70 | 100 |
| (parts | Polyisocyanate | 45.933 | 45.324 |
| by | Foaming Agent (Water) | 4.5 | 4.5 |
| weight) | Foam Stabilizer (PRX607) | 2.9 | 2.9 |
| | Catalyst (NEM) | 0.48 | 0.48 |
| | Foam Stabilizer (AX-31) | 0.5 | 0.5 |
| | Catalyst (33LV) | 1 | 0.2 |
| | Foam Stabilizer (SH192) | 0.7 | 0.7 |

| | | |
|---|---|---|
| Isocyanate Index | 90 | 90 |
| Resulting pH Value | 6.5 | 7.0 |

※The content of polyacrylic sodium in 100 parts by weight of the polyol component (the total of polyol 1 and polyol 2) is 4.5% by weight.

It is apparent from Table 1 that the flexible polyurethane foam of the present invention is weak acid when it is wet.

1. A flexible polyurethane foam containing a weak acid component whereby said foam is weak acid when it is wet.

2. A flexible polyurethane foam as claimed in claim 1, wherein the polyurethane foam is manufactured by foaming a raw compound containing the weak acid component.

3. A flexible polyurethane foam as claimed in claim 1, wherein the weak acid component is acrylic alkali metallic salt and/or polymers thereof.

4. A flexible polyurethane foam as claimed in claim 3, wherein the weak acid component is acrylic sodium and/or polymers thereof.

5. A flexible polyurethane foam as claimed in claim 1, wherein the polyurethane foam is manufactured by foaming the raw compound containing a polyol component, polyisocyanate component, foaming agent and other additives, at least a part of said polyol component being polyol containing the weak acid component.

6. A flexible polyurethane foam as claimed in claim 5, wherein the content of the weak acid component in the polyol component is in a range of 0.75 to 15% by weight.

7. A flexible polyurethane foam as claimed in claim 5, wherein the polyol containing the weak acid component is prepared by first adding acrylic alkali metallic salt in polyol and mixing them, and then polymerizing the acrylic alkali metallic salt in the polyol to produce polymers of the acrylic alkali metallic salt.

8. A flexible polyurethane foam as claimed in claim 7, wherein the polymers of the acrylic alkali metallic salt have an average particle diameter of 0.5 to 10 μm.

9. A flexible polyurethane foam as claimed in claim 1, wherein the flexible polyurethane foam has an weak acidity of pH6.0 to 6.8 when it is wet.
